(19) United States
(12) Patent Application Publication
(10) Pub. No.: US 2005/0251600 A1
(43) Pub. Date: Nov. 10, 2005

(54) Multitask data transfer system on ATA bus

(76) Inventor: Jaan-Huei Chen, Taipei City (TW)

Correspondence Address: HOFFMAN WARNICK & D'ALESSANDRO, LLC, 75 STATE STREET, 14TH FL, ALBANY, NY, 12207, US

(21) Appl. No.: 11/105,267

(22) Filed: Apr. 13, 2005

(30) Foreign Application Priority Data
Apr. 14, 2004 (TW) 093110422

(51) Int. Cl. G06F 13/00

(52) U.S. Cl. 710/100

(57) ABSTRACT

A data transferring system comprises a host controller including an ATA bus host interface, a first data storage device, a second data storage device, and a switch. The switch directs a set of host chip-selection signals from the ATA bus host interface to a first set of chip-selection signal or to a second set of chip-selection signal, and these connect to the first and the second data storage device. When the processing priority of the second data storage device is higher than the processing priority of the first data storage device, when the host controller does not assert the chip-selection signals, and when the data storage device is not in the direct memory access (DMA) mode, the host controller controls the switch to connect to another set of chip-selection signals according to a channel selection signal after the host controller issues a first command to the first data storage device. Such arrangement enables the host controller to issue a second command to the second data storage device without interrupting or changing the command state of the first data storage device before the first command to the first data storage device is completed.

### BACKGROUND OF THE INVENTION

1. Field of the Invention

This present invention relates to a data transferring system; it is especially about a data transferring system that utilizes an advanced technology attachment bus (ATA bus) to transmit commands and data.

2. Description of the Prior Art

ATA bus is a widely used data transferring standard. For example, in a personal computer system, ATA bus is utilized to transmit data between the host controller and the hard disk drive, or between the host controller and the optical disk drive. The ATA specification has been disclosed, and is well known in the industry.

Referring to FIG. 1, FIG. 1 is a schematic diagram of the data transferring system 10 of the prior art. The data transferring system 10 comprises an ATA bus signal transmission line 12, a host controller 14, a hard disk drive 16, and an optical disk drive 18. The ATA bus signal transmission line 12 connects the hard disk drive 16 and optical disk drive 18 to the host controller 14.

The ATA bus signal transmission line 12 can be a transmission line comprising forty lines of signals or eighty lines of signals. As shown in FIG. 1, the host controller 14, the hard disk drive 16, and the optical disk drive 18 connect with each other in series connection through the ATA bus host interface 15 and the ATA bus device interfaces 17 and 19 by the ATA bus signal transmission line 12. When the host controller only has a single ATA bus host interface, these devices (i.e. the hard disk drive 16, and the optical disk drive 18) can only connect in series connection.

Referring to the FIG. 2, FIG. 2 is a schematic diagram of the data transferring system 20 of the prior art. In the data transferring system 20, the host controller 14, the hard disk drive 16, and the optical disk drive 18 connect with each other by the parallel connection; in fact, it uses two sets of the ATA bus signal transmission line 12 and 13. Comparing with the data transferring system 10 of FIG. 1, the data transferring system 20 of FIG. 2 needs to add another set of ATA bus host interface 21 because it requires an additional ATA bus signal transmission line 13. The parallel connection is generally used when the host controller needs to control or access two data storage devices at the same time.

According to the ATA bus manual, in the data transferring system 10 of FIG. 1, after the host controller 14 starts to send command to the optical disk drive 18, and before the optical disk drive 18 finishes executing the command, the host controller 14 cannot give another command to the hard disk drive 16 or transmit data in the system. In other words, in the case where the host controller and two of the storage devices connect with each other in series connection, after the host controller 14 starts to send command to one of the storage devices and before this storage device finishes executing the command, the host controller 14 cannot send command to, or have data transmission with the other storage device.

Referring to FIG. 3 and FIG. 1, FIG. 3 is a time diagram of the activities of the hard disk drive 16 and the optical disk drive 18 of FIG. 1. As shown in FIG. 3, the T axis represents time; the HDD axis stands for the different activities according to time sequence that is processed by the hard disk drive 16, and the DVD axis stands for the different activities according to time sequence that is processed by the optical disk drive 18 (for example, a DVD disk drive). Referring to the DVD axis, the host controller 14 issues a command to the optical disk drive 18 by the ATA bus host interface 15, the ATA bus transmission line 12, and the ATA bus device interface, so there is a command time interval (CMD) 22. The optical disk drive 18 needs some time to prepare for executing the command, so there is a waiting time interval 24. According to the command issued by the host controller 14, the optical disk drive 18 starts to transmit data to the host controller 14 or to receive data from the host controller 14, and thus there is a transferring time interval (XFER) 26. The optical disk drive 18 is in the working state from the time point the host controller 14 issues a command to the optical disk drive 18, throughout the time intervals 22, 24, 26, and until the transmission is finished.

In a similar way, referring to the HDD axis, the different related activities in the hard disk drive 16 correspondingly require the command time interval 28, the waiting time interval 30, and the transferring time interval 32. The hard disk drive 16 is in the working state throughout the time intervals 28, 30, and 32.

However, referring to the waiting time interval 24 of the DVD axis and the waiting time interval 30 of the HDD axis of FIG. 3, neither does the host controller send command to the optical disk drive 18 and the hard disk drive 16, nor does the optical disk drive 18 and the hard disk drive 16 execute command or transfer data. In other words, during the waiting time interval 24 and 30, the ATA bus host interface 15 is considered to be in an idle state, and it is a waste of transmission resource.

According to the ATA specification, if there are two devices (for example, a hard disk drive 16 and a optical disk drive 18) connected to the host controller 14 by a same ATA bus transmission line, the host controller cannot issue a command to one device (for example, the hard disk drive 16) while the other device (for example, the optical disk drive 18) is in the working state. However, different kinds of data storage devices require different duration of time to operate. As shown in FIG. 3, the time, which is taken up by the optical disk drive 18, is generally longer than the time taken up by the hard disk drive 16, and the media (for example, a CD-ROM disk or a DVD-ROM disk) loaded into the optical disk drive 18 is replaceable, so the waiting time interval 24 may vary and could be much more longer if the loaded media is difficult to access. The difference of the waiting time not only shows the fact that transmission resources are wasted but also increases unanticipated time delay; when the host controller needs to control or access the hard disk drive 16, the longest delay can be the sum of the time intervals 22, 24, 26. As shown in FIG. 3, the waiting interval 24 of the optical disk drive 18 may be long enough to cover the command time interval 28, waiting time interval 30, and transferring time interval 32 of the hard disk drive 16. However, according to the ATA specification, the waste of the transmission resource, which is caused by the waiting time interval, is unrestricted in the data transmission system of the prior art.

To deal with the problem of wasting transmission resource, the command overlapped feature has been introduced in the new ATA specification (for example, ATA/ATAPI-7 specification). However, it is not practical to modify the products which have already been widely spread out in the market. In addition, to support the new command overlapped feature, a more sophisticated design is required and the cost of the products would increase. Furthermore, a data transmission system may includes a plurality of data storage devices; if every data storage device is required to support the command overlapped feature in order to avoid wasting transmission resources, the increased cost is multiplied by the number of data storage devices being connected. In still another aspect, the command overlapped feature will increase the time of device state transition; even if the transition time can be ignored, the delay of the optical disk drive 18 in the time interval 22 and 26 may still occur when the host controller 14 want to control or access the hard disk drive 16, so it could not be done immediately.

If we apply the data transmission system of FIG. 2, the host controller 14 connects to the hard disk drive 16 and the optical disk drive 18 respectively by two independent ATA bus host control interfaces 15 and 21. When the host controller 14 controls or accesses the optical disk drive 18, and there is a delay, the host controller 14 can still directly control or access the hard disk drive 16 by the other independent ATA bus host control interface 21, and there will not be extra delay time. Although it can solve the problem of command delay between the host controller 14 and the hard disk drive 16, the commands from the host controller 14 to the hard disk drive 16 and the optical disk drive 18 are dispersed to two independent ATA bus host control interfaces 15 and 21, and the utility rate of the individual ATA bus host interface is lower than the ATA bus host interface of the data transmission system in FIG. 1. Because the host controller 14 needs to incorporate an additional ATA bus host interface 21, it needs to incorporate corresponding hardware; if the host 14 is a single system chip, it needs more pins for the additional ATA bus host interface, and that increases the cost of host 14.

Therefore, it is an object to develop a data transmission system which can perform multitask in the ATA bus when the host controller only has a single ATA bus host interface, when it is connected to two or more devices with the ATA bus device interface, and when the device which is connected does not support the command overlapped feature, so as to avoid wasting transmission resource of the ATA bus host interface and ensure the immediacy of the control and the access of some of the devices.

### SUMMARY OF THE INVENTION

An object of the present invention is to provide a data transmission system that can avoid wasting transmission resource of the ATA bus (advanced technology attachment bus) host interface and can ensure the immediacy of the control and the access of some of the devices. It's also an object of the invention to provide a data transmission system which does not need the command overlapped feature for multitasking in the ATA bus.

According to an embodiment, a data transmission system is disclosed. The data transmission system comprises a host controller with a single ATA bus host interface, the first and the second data storage devices with the ATA bus device interface, the ATA bus transmission lines of the devices, and a single switch.

In the embodiment, the ATA bus host interface can transmit commands or data by one of a plurality of programmed input/output (PIO) modes or direct memory access (DMA) modes. Furthermore, the ATA bus host interface includes a chip-selection signal output. The first and the second data storage device connect to the host controller through the ATA bus, where the first data storage device transfers in the PIO mode.

The switch can switch the host chip-selection signals between two corresponding sets of chip-selection signals, which can be respectively sent to the first and second storage device by corresponding signal channels. The switch only allows one signal channel to be available each time.

After the host controller starts to issue a first command to the first data storage device, and also that the ATA bus device interface of the first data storage device is not in the DMA mode, while the host controller does not assert the chip selection signal, the switch can switch the set of chip selection signals to other signal channels, according to the channel selection signal from the host controller; thus, the host controller can directly give a second command to the second data storage device without interrupting the process of the first command or changing the processing state of the first data storage device before the process of the first command is finished.

If there is a third data storage device, and the priority of the host controller to control or access the third data storage device is the same as the first data storage device, meaning that the host controller does not need to control or access the third data storage device while the host controls or accesses the first data storage device, then the third data storage device and the first data storage device can be connected to the same ATA bus signal transmission line.

Comparing with the prior art, the data transmission system of the embodiment can perform multitask without requiring the two or more data storage devices to be equipped with the command overlapped feature as defined in the new ATA specification, and the host controller only needs a single ATA bus host interface. Moreover, the data transmission system not only conforms to the consideration of the cost factor but also increases the efficiency of the data transmission by bringing the effect of the multitasking access into full play, and it ensures the immediacy of the commands from high priority device.

The advantage and spirit of the invention may be understood by the following recitations together with the appended drawings.

### BRIEF DESCRIPTION OF THE APPENDED DRAWINGS

FIG. 1 is the diagram of the data transmission system of the prior art.

FIG. 2 is a diagram of the data transmission system of the prior art.

FIG. 3 is time diagram of the activities of the hard disk drive and the optical disk drive of FIG. 1 versus time.

FIG. 4 is a diagram of the data transmission system of the embodiment that can perform multitask in the ATA bus.

FIG. 5 is the time diagram of the activities of the first and the second data storage devices and of FIG. 4 versus time.

FIG. 6 illustrates the established signals of the ATA bus according to the ATA specification.

FIG. 7 displays the established definitions of the command block register according to the ATA specification.

FIG. 8 displays the established definitions of the control block register according to the ATA specification.

FIG. 9 is a diagram of the data transmission system of another embodiment.

### DETAILED DESCRIPTION OF THE INVENTION

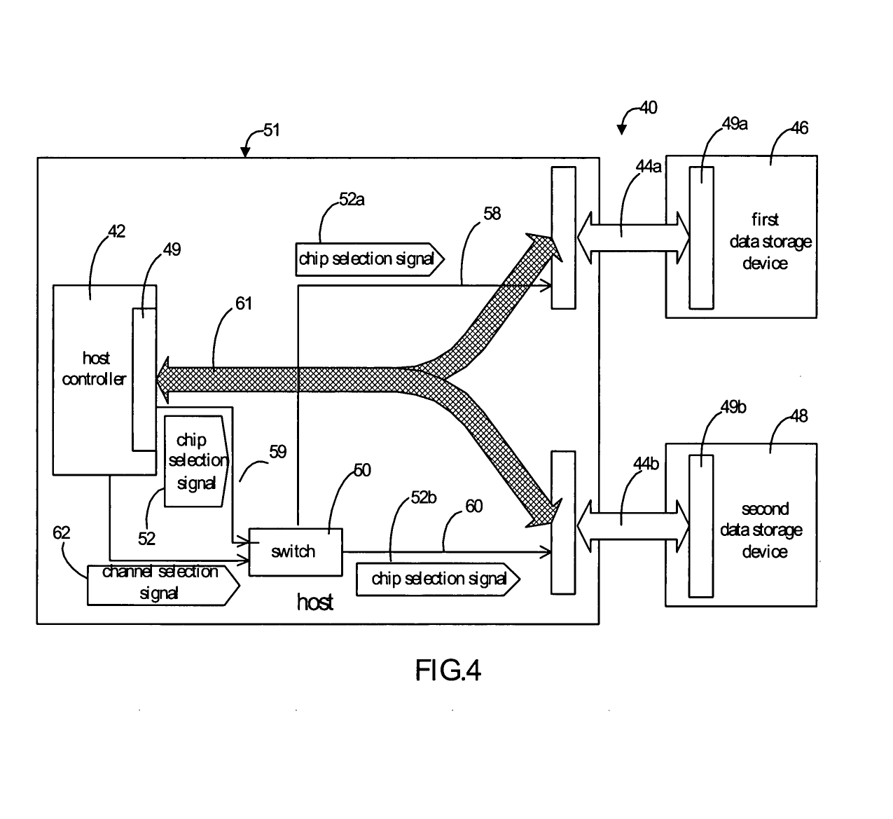

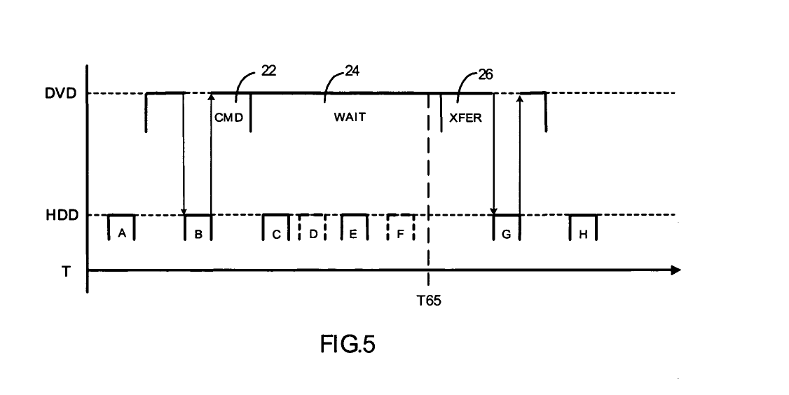

Referring to the FIG. 4, FIG. 4 is a diagram of the data transmission system 40 of an embodiment that can perform multitask in the ATA bus without using the command overlapped feature as defined in the new ATA specification. The data transmission system 40 comprises a host device 51, two ATA bus signal transmission lines 44a and 44b, a first data storage device 46 and a second data storage device 48 both with the ATA bus device interface. The host device 51 includes a host controller 42 with an ATA bus host interface 49, and a switch 50. There are two data storage devices in this embodiment. According to the above conditions, the host device 51 can connect with two data storage devices in the same ATA bus host interface 49. The data transmission system 40 may also be used for three or more data storage devices by increasing the number of signal channels of the switch 50.

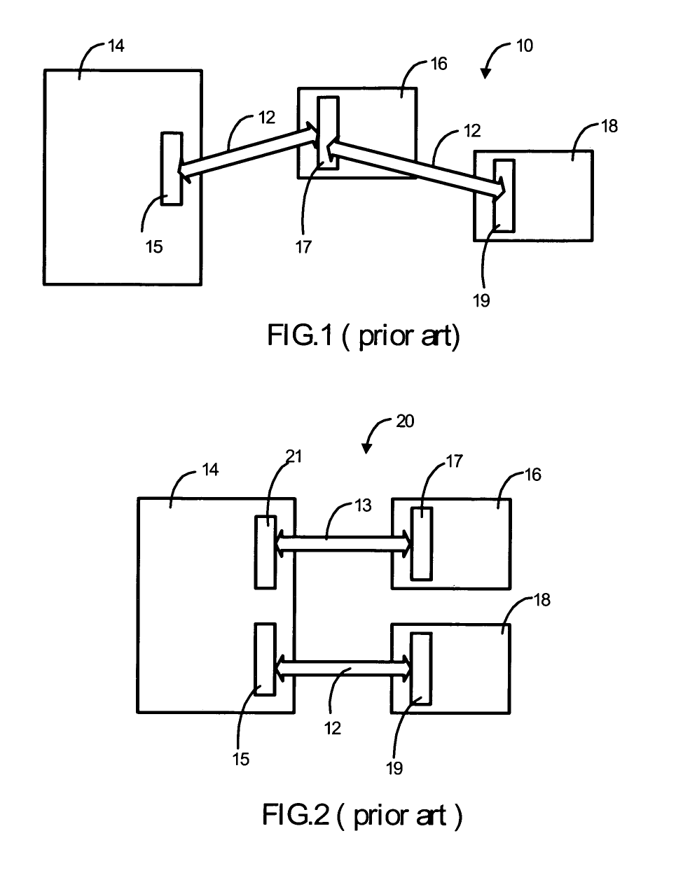

The function of the host controller 42 is basically the same as the host controller 14 of FIG. 1. The host controller 42 has an ATA bus host interface for transferring commands or data in a PIO mode or in a DMA mode, and it can issue commands to the data storage devices 46 or 48 to control/access the data storage devices 46 or 48. The host controller 42 and the switch 50 can be integrated in a signal chip (that is, implemented in a monolithic substrate), and the channel selection signal 62 could be generated by a hardware circuit or by an outputting signal of a software program, so as to control the switch 50.

The ATA bus signal transmission line 44a and 44b can be used for transferring commands or data in the programmed input/output mode (PIO mode) or for transferring the data in the direct memory access mode. Moreover, the transmission signal of the ATA bus signal transmission line 44a, 44b comprises a set of chip selection signals 58 and 60.

The first data storage device 46 and the second data storage device 48 connect with the host device 51 by the ATA bus signal transmission line 44a and 44b. The control priority and the data access priority of one of the data storage devices 46, 48, which are controlled by the host controller 42, is higher than the other one, and the data storage device with the lower priority is in the PIO mode. In the embodiment, the first data storage device 46 is an optical disk drive; and the second storage device 48 is a hard disk drive. In general system applications, the processing speed of the hard disk drive is much faster than the processing speed of the optical disk drive, and the control priority and the access priority of the hard disk drive in the host is higher than that of the optical disk drive. In this embodiment, the control priority and the data access priority of the second data storage device 48 is higher than that of the first data storage device 46, so the first data storage device 46 is in the PIO mode and the second data storage device 48 is in the PIO mode or the DMA mode.

The switch 50 directs the set of chip selection signal 52 of the host controller 42 into two sets of chip selection signals 52a and 52b, and the two sets of chip selection signals are respectively transmitted to the first data storage device 46 and the second data storage device 48 by the ATA bus signal transmission line 44a or the ATA bus signal transmission line 44b. As shown in FIG. 4, the switch 50 can direct the chip selection signal 52 to the first set of chip selection signal 52a and transmit that from the host device 51 to the first data storage device 46. Alternatively, the switch 50 can also direct the chip selection signal 52 to the second set of chip selection signal 52b and transmit that from the host device 51 to the second data storage device 48.

As shown in FIG. 4, the ATA bus host interface 49 of the host controller 42 is a complete ATA bus host interface in the host device 51, and the input/output signal of the interface can be divided into the chip selection signal 52 and a partial ATA bus host interface signal 61. After the signal 61 and the chip selection signal 52a or the chip selection signal 52b, which is directed, are combined into a complete ATA bus host interface signal, the complete ATA bus host interface signal could be transmitted to the first data storage device 46 or the second data storage device 48 by the ATA bus signal transmission lines 44a or 44b.

After the host controller 42 issues a first command to the first data storage device 46 in the data transmission system 40, if the host controller 42 does not assert the chip-selection signal 52 and the first data storage device 46 is also not in the direct memory access (DMA) mode, the switch 50 can switch the first set of chip selection signal 52a to the second set of chip selection signal 52b according to a channel selection signal 62. Thus, the host controller can issue a second command to the second data storage device without interrupting or changing the command state of the first data storage device before the first command and corresponding operations are completed.

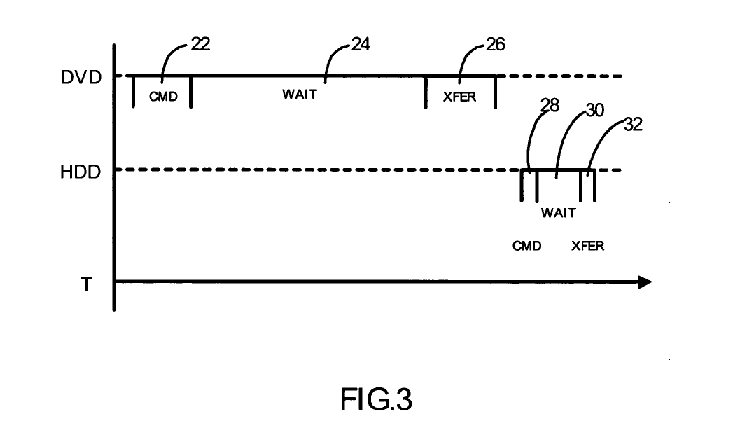

Referring to FIG. 5 and comparing to the prior art of FIG. 3, FIG. 5 is a time diagram of the activities of the first and the second data storage devices 46 and 48 of FIG. 4 versus time. As shown in FIG. 5, the T axis is the time axis; the DVD axis stands for the activities according to time sequence that is processed by the first data storage device 46; the HDD axis stands for the activities according to time sequence that is processed by the second data storage device 48. The time intervals A, B, C, D, E, F, G, H are different intervals which respectively stand for the control or the data transmission of the host controller 42 to the second data storage device 48, and each of the time intervals comprises a command time interval (CMD), a waiting interval (WAIT), and a transferring time interval (XFER).

According to the embodiment, the host controller 42 can utilize the waiting interval 24 of the first data storage device 46 to control or to access the second data storage device 48, so the transmission resource of the time interval C and time interval E of FIG. 5 are obtained.

Besides, the data transmission system 40 of the FIG. 4 could select the second data storage device 48 during the command time interval 22 and the transferring time interval 26; thus, it could control or access the second data storage device 48 immediately. This method is the same as what mentioned before; the host controller 42 selects a second signal channel 60 by sending out the corresponding channel selection signal 62. As shown in FIG. 5, the host device 51 could pause the command or the data transferring of the first data storage device 46 and could select the second data storage device 48 so as to control or access the second data storage device 48, such as in the time interval B and the time interval G; after that, the host device 51 continues the unfinished control or access to the first data storage device 46. In this way, the host controller 42 could control or access the second data storage device 48 immediately whenever it is desired, and such operation would not be delayed by the command time interval 22 and the transferring time interval 26 of the first data storage device.

Furthermore, when the host controller 42 is waiting for the first storage device 46 to be ready during the waiting time interval 24, the host controller 42 could make the switch 50 switch between two of the signal channels back and forth by sending out the channel selection signal 62 to the switch 50 repeatedly. The host controller 42 could determine whether to access the first data storage device 46 or not by the device ready state of the first storage device 46. As shown in FIG. 5, after a device ready point T65, the host controller 42 can find out the first storage device 46 is ready, and it can then prepare to access the first data storage device 46. If the first data storage device 46 is not ready, the host controller 42 can switch to the second data storage device 48 and process the next command to make use of more data transmission resource, such as in time interval D and time interval F.

If more data transmission resource is to be made used of, the host controller 42 can also switch back to the first data storage device 46 to process a span of the data transmission during the waiting time interval of the time interval G while the second data storage device is not in the DMA mode, and then it switches to the second data storage device again to process the data transmission.

If it is desired that the host controller 42 issues a second command to the second data storage device without interrupting or changing the command state of the first data storage device before the first command is completed, the data transmission system of the prior art needs a command overlapped feature in the first data storage device 46.

The command overlapped feature makes the data storage device perform a bus release operation when the data storage device needs more time to finish the execution of the command, so the other data storage device which is connected to the ATA bus can be used by the host controller 42. However, the process of command and data transmission cannot be interrupted. Therefore, during the command time interval and the transferring time interval of the first data storage device, the host controller 42 could not switch to the second data storage device. In the data transmission system 40 of the present invention, the first data storage device 46 and the second data storage device 48 do not use the command overlapped feature as defined in the new ATA specification, and the data transmission system 40 could issue the second command to the second data storage device in any stage of the executing process of the first command by the aforementioned method of the embodiment.

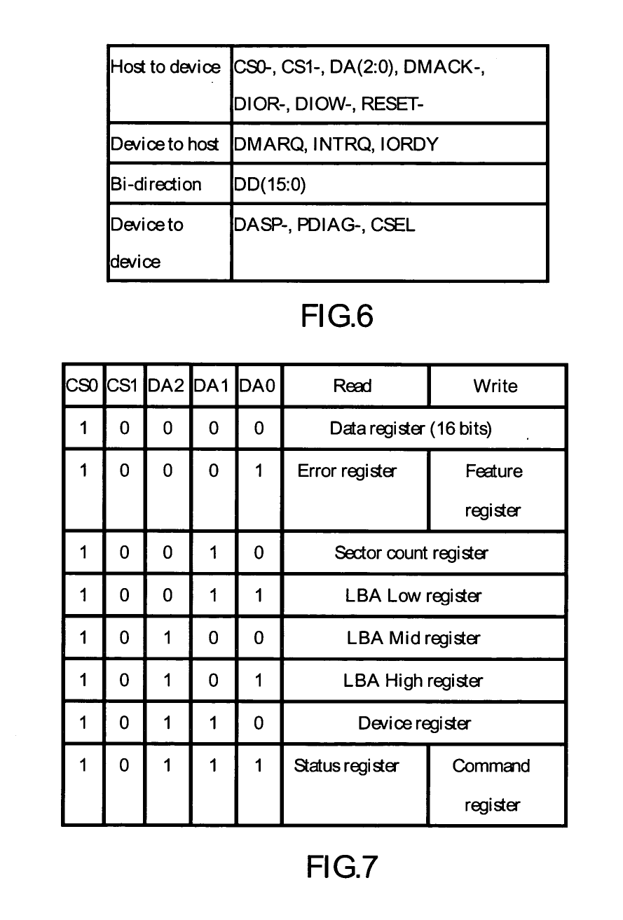

Referring to the FIG. 6, FIG. 6 illustrates the established signals of the ATA bus according to the ATA specification. Each of the four rows in FIG. 6 stands for various established signals according to the direction of the signal transmission. The first row of the FIG. 6 records various signals of the host controller 42 that is sent out to the data storage devices. In the data transmission system 40 of FIG. 4, the chip selection signal 52 comprises a CS0 signal and a CS1 signal. The CS0 signal and the CS1 signal are signals from the host controller 42 which are sent to one of the data storage devices, and these signals are used to define whether the corresponding data storage device should receive the transmission signal from the ATA bus device interface.

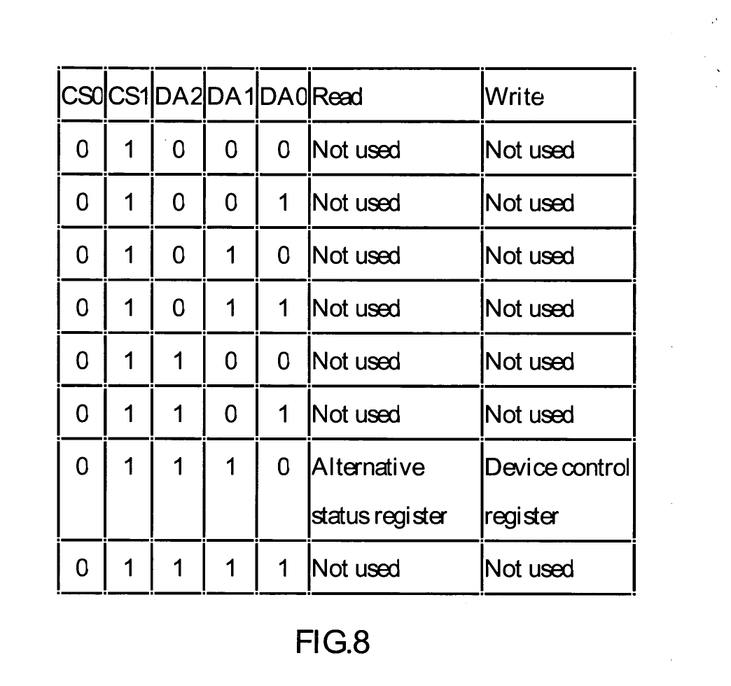

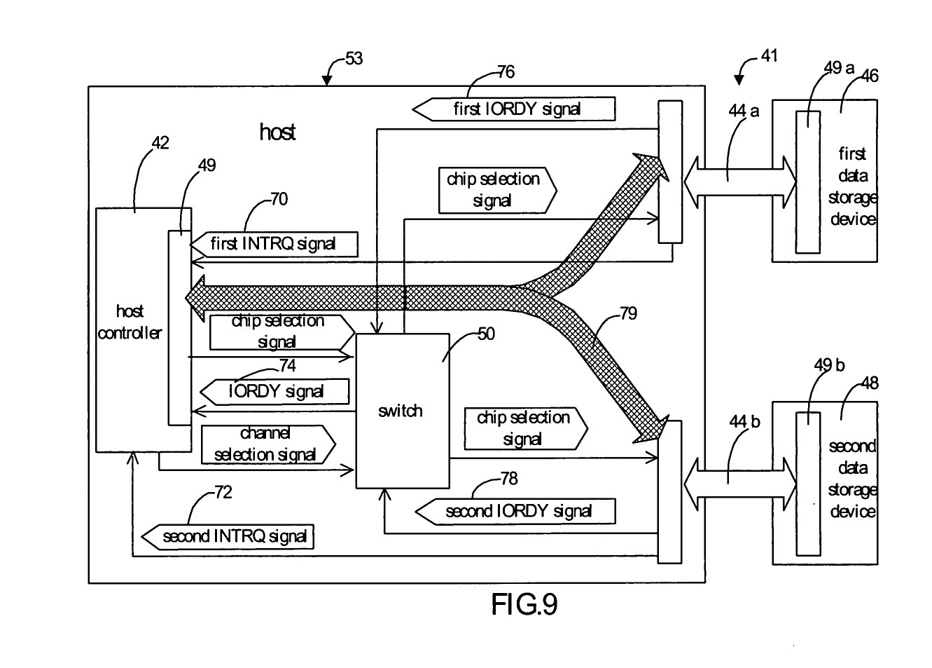

Referring to FIG. 7, FIG. 8, and FIG. 4, FIG. 7 illustrates the established definitions of the command block register according to the ATA specification; FIG. 8 illustrates the established definitions of the control block register according to the ATA specification. In the data transmission system 40 of FIG. 4, the data storage devices 46, 48 comprise a plurality of I/O registers, such as shown in FIG. 7 and FIG. 8, and the host controller 42 could write commands and data into the I/O registers. The host controller 42 selects the device 0 or the device 1 to issue commands, store, or load the data after the device is selected, according to various signals which are written into the I/O registers by the ATA bus.

As shown in FIG. 6, the ATA bus further comprises a DMARQ signal, an INTRQ signal, and an IORDY signal. The DMACK signal is a signal that is transmitted from the host controller 42 to the data storage devices. The DMARQ signal, the INTRQ signal, and the IORDY signal are signals transmitted from the data storage device to the host controller 42.

In this data transmission system, only the high priority data storage device can use the DMA mode, so there is no conflict problem about the device signal outputting the DMARQ signal. By setting up the devices' I/O registers, only one priority level of the devices with could use the INTRQ signal at the same time. If the host controller can provide an extra INTRQ signal input, both the devices with high priority and low priority can use the INTRQ signal output at the same time. The use of the IORDY signals is different according to the differences in devices with low priority. If the device does not send out the IORDY signal when the device has not received the chip selection signal from the device, the IORDY signal output of the devices with high priority and low priority will not conflict; if it is not the case, the host controller could use a low speed PIO mode, which does not need to use the IORDY, to avoid the IORDY output conflict of the devices with high priority and low priority.

Referring to FIG. 9, FIG. 9 is a diagram of the data transmission system 41 of another embodiment of the present invention. Comparing with the data transmission system 40 of FIG. 4, the data transmission system 41 of FIG. 9 further utilizes the INTRQ signal and the IORDY signal of the ATA bus listed in FIG. 6.

In the data transmission system 41 of FIG. 9, the host controller 42 provides two INTRQ signal inputs for the two devices: a first INTRQ signal 70 and a second INTRQ signal 72. The first INTRQ signal 70 is transmitted from the first data storage device 46 to the host controller 42. The second INTRQ signal 72 is transmitted from the second data storage device 48 to the host controller 42.

The advantage of the host controller 42 adding the second INTRQ signal input is that the host controller 42 could get more transmission resource without having to switch between the first data storage device and the second storage device by the switch 50 while waiting for the first data storage device to be ready. In this way, the readiness of the first data storage device could be known by the inputting of the device INTRQ signal, thus decreasing the device switching activities of the host controller and increasing the control or the data access activities of the second data storage device; it also further increases the efficiency of the usage of the ATA bus resource. If the host controller 42 does not provide INTRQ signal input for two devices, it is also feasible that the switch 50 provides INTRQ signal input for both of the two storage devices and the INTRQ signal output for one of the two storage devices. When the switch 50 receives the channel selection signal to switch the chip selection signal, the switch 50 also directs the corresponding device INTRQ signal input to the INTRQ output. Although such implementation enables the host controller 42 to detect whether an individual storage device is sending out the INTRQ signal, the host controller 42 may still need to continuously switch between the two different channels so as to get the readiness of any one of the storage devices.

In the data transmission system 41 of FIG. 9, the switch 50 could also provide two IORDY signal inputs, which are the first IORDY signal 76 and the second IORDY signal 78. The first IORDY signal 76 is transmitted from the first data storage device 46 to the switch 50. The second IORDY signal 78 is transmitted from the second data storage device 48 to the switch 50. As mentioned before, if the switch 50 is capable of switching the IORDY signals, then the storage device could output the IORDY signal even when it has not yet received the chip selection signal, and both the two storage devices could still be used in the PIO mode without the compatibility problem.

The partial ATA bus 79 of the host device 53 is an ATA bus that does not include the chip selection signal CS0, CS1, the IORDY signal, and the INTRQ signal.

Comparing with the data transmission system 40 of FIG. 4, the data transmission system 41 of FIG. 9 further includes the second INTRQ input in the host controller 42 or includes IORDY signal switching capability in the switch 50 so as to handle the first INTRQ signal 70, the second INTRQ signal 72, the first IORDY signal 76, and the second IORDY signal 78. These two modifications are optional and could be used when applicable.

Comparing with the prior art, the data transmission systems disclosed in the embodiments do not need to use the data storage device with the command overlapped feature, and they also do not need to add the second set of independent ATA bus host interface to process the multitasks in the ATA bus; therefore, they could avoid wasting ATA bus transmission resource, and they could shorten the command processing delay time of the high priority device. According to the embodiments, the data transmission systems not only conform to the cost factor but also increases the efficiency and the immediacy of the data transmission by using the multitask function.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A data transferring system, comprising:
a host controller including an Advanced Technology Attachment bus (ATA bus) host interface and a channel selection signal output for providing a channel selection signal, the ATA bus host interface is capable of transferring a plurality of commands or data by a programmed input/output (PIO) mode or a direct memory access (DMA) mode, and the ATA bus host interface including a chip-selection signal output for providing a chip-selection signal;
a switch coupled to receive the chip selection signal and the channel selection signal, and direct the chip-selection signal to a first chip-selection signal or a second chip-selection signal according to the channel selection signal; and
a first storage device and a second storage device, each having the ATA bus device interface coupled to the host controller by the ATA bus and also coupled to the switch, the processing priority of the second storage device being higher than the processing priority of the first storage device, the first storage device receiving the first chip-selection signal, and the second storage device receiving the second chip-selection signal, and the first storage device is in the PIO mode;
while the host controller controls the first storage device, the host controller controls the switch without changing the state of the first storage device, when the host controller does not assert the chip-selection signals, and the first storage device is not under the DMA mode, the host controller controls the switch to couple to the second chip-selection signal, and the host controller controls the second storage device, or accesses data on the second storage device.

2. The data transferring system of claim 1, wherein an interrupting request signal output of the first storage device, and an interrupting request signal output of the second storage device can be connected to an interrupting request signal input of the ATA bus host interface, and only one of the first or the second storage device enabling the interrupting request signal output at the same time.

3. The data transferring system of claim 1, wherein the switch has at least an interrupting request signal output of the first storage device and an interrupting request signal output of the second storage device connecting to the switch, and the switch, according to the channel selection signal output, only connecting one of the interrupting request signal outputs of the first and the second storage devices to the ATA bus host interface at the same time.

4. The data transferring system of claim 1, wherein an interrupting request signal output of the first storage device connecting to a first interrupting request signal input of the host controller, and an interrupting request signal output of the second storage device connecting to a second interrupting request signal input of the host controller.

5. The data transferring system of claim 1, wherein an input/output ready signal output of the first storage device and an input/output ready signal output of the second storage device connecting to the switch, and the switch, according to the channel selection signal output, only connecting one of the input/output ready signal outputs of the first and the second storage devices to the ATA bus host interface at the same time.

6. The data transferring system of claim 1, wherein an input/output ready signal output of the first storage device connecting to a first input/output ready signal input of the host controller, and an input/output ready signal output of the second storage device connecting to a second input/output ready signal input of the host controller.

7. The data transferring system of claim 1, when the host controller controls the first storage device, the host controller sends out the channel selection signal to trigger the switch to connect the chip-selection signals to the second chip-selection signal, and the host controller then controls the second storage device; and during the period of waiting for a response of the second storage device which is not in the DMA mode, the host controller further sends out the channel selection signal to trigger the switch to connect the chip-selection signal to the first chip-selection signal, and the host controller then controls the first storage device; thereafter, the host controller sends out the channel selection signal to control the second storage device.

8. The data transferring system of claim 1, wherein the host controller and the switch are integrated into a single chip.

9. A host device for communicating to a first device and a second device without supporting a command overlapped feature as defined in the ATA specification, each of the first device and the second device has an ATA (Advanced Technology Attachment) bus device interface for communicating with the host device, the host device comprising:
a host controller including an ATA bus host interface and a channel selection signal output for providing a channel selection signal, the ATA bus host interface is capable of transferring a plurality of commands or data by a programmed input/output (PIO) mode, and the ATA bus host interface includes a chip-selection signal output for providing a chip-selection signal;
a switch coupled to receive the chip selection signal and the channel selection signal, and is capable of directing the chip-selection signal to the first device or the second device according to the channel selection signal; and
while the host controller issues a first command to the first storage device and the first command and corresponding operation are not completed yet, the host controller controls the switch to direct the chip-selection signal to the second chip-selection signal, so the host controller is capable of controlling the second storage device or accessing data on the second device.
